(19) United States
(12) Patent Application Publication
(10) Pub. No.: US 2010/0319652 A1
(43) Pub. Date: Dec. 23, 2010

(54) ROTOR HOUSING ASSEMBLY FOR ROTARY ENGINE AND RELATED DEVICES AND METHODS

(75) Inventors: William L. Cooper, Riviera Beach, FL (US); J. Scott Webber, Redding, CA (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(73) Assignee: ROTARY ENGINE TECHNOLOGIES, INC., Riviera Beach, FL (US)

(21) Appl. No.: 12/487,055

(22) Filed: Jun. 18, 2009

(51) Int. Cl. F02B 53/00; F01M 1/02; F01L 7/00

(52) U.S. Cl. 123/200; 123/196 R; 123/190.1

(57) ABSTRACT

A rotor housing assembly is adapted such that a barrel valve is arranged to regulate the flow of fuel/air mixture both from outside the housing assembly into an internal lubrication flow path and from the internal lubrication flow path into an internal chamber. The barrel valve includes a substantially cylindrical valve member diagonally traversed by a separation plate, dividing the interior of the valve member into an inlet chamber and an outlet chamber. Fuel/air mixture entering the housing assembly from outside passes through the inlet chamber and fuel/air mixture entering the internal chamber passes through the outlet chamber.

### FIELD OF THE INVENTION

The present invention relates to rotary engines, and more particularly, to rotor housing assemblies for rotary engines.

### BACKGROUND OF THE INVENTION

Rotary engines, also known as Wankel engines, are used in a large number of applications, from automobiles, aircraft and boats to power generation and power tools. In one type of rotary engine, referring to FIGS. 7-11, a rotor housing assembly 110 is formed from a front side housing 112, a rotor housing 114, a rear side housing 116, and a barrel valve 118. In addition to housing a rotor 134 within an internal chamber 140 (sometimes referred to as a tracoidal chamber), the housing assembly 110 directs, prior to combustion, a combination of fuel and air (the “fuel/air mixture”) to help lubricate and cool the rotor 134, shaft 130 and other power train components.

The fuel/air mixture first enters the rotor housing assembly 110 at a front side internal passage inlet 122 and travels through a front side internal passage 120 to a front side internal passage outlet 124 near the rotor 134. (A small portion of the fuel/air mixture passes through idling openings 180 in the barrel valve 118 to enter a barrel valve housing 142, and pass from thence to the internal chamber 140 through an internal chamber fuel/air inlet passage 146.)

After passing through and around various power train components, the fuel/air mixture, excepting the small portion, enters a rear side internal passage 156 through a rear side internal passage inlet 158 and exits through a rear side internal passage outlet 160. The fuel/air mixture enters the barrel valve housing 142, through an open end of the barrel valve 118: The fuel/air mixture passes through a fuel/air outlet opening 184 of the barrel valve 118 and into the internal chamber 140 through the internal chamber fuel/air inlet passage 146. Once in the internal chamber 140, the fuel/air mixture travels with the rotor 134, cooling and lubricating the rotor 134 and apex seals, before being combusted and exhausted as known in the art.

Thus, in this type of rotary engine housing assembly, one mechanism (the barrel valve) regulates entry of the fuel/air mixture into the internal chamber. To regulate entry of the fuel/air mixture into the housing assembly, a separate mechanism (not shown) must be provided.

### SUMMARY OF THE INVENTION

Based on the foregoing, it is an object of the present invention to provide an improved rotary engine rotor housing assembly, as well as an improved method for regulating fuel/air flow through a rotary engine housing assembly.

According to an embodiment of the present invention, a rotary engine rotor housing assembly includes a rotor housing at least partially defining an internal chamber therein, a front side housing arranged on a front side of the rotor housing, a rear side housing arranged on a rear side of the rotor housing, and a barrel valve arranged in a barrel valve housing defined in the housing assembly. An internal lubrication flow path is defined within the housing assembly and the barrel valve is operable to regulate entrance of fuel/air flow both into the housing assembly and from the internal lubrication flow path into the internal chamber.

According to an aspect of the present invention, the barrel valve includes a valve element defining an interior volume, a fuel/air inlet opening and a fuel/air outlet opening being defined in the valve member in communication with the interior volume. The barrel valve also includes a separation plate dividing the interior volume into an inlet chamber, directly communicating with the fuel/air inlet opening, and an outlet chamber, directly communicating with the fuel/air outlet opening.

According to a method aspect of the present invention, a method of regulating fuel/air mixture flow in a rotary engine rotor housing assembly includes arranging a single valve in the path of a fuel/air mixture both from outside the housing assembly into an internal lubrication flow path, and from the internal lubrication flow path into an internal chamber. The single valve is operated to simultaneously regulate the fuel/air flow into the housing assembly and into the internal chamber.

These and other objects, aspects and advantages of the present invention will be better understood in view of the drawings and following detailed description of a preferred embodiment.

### BRIEF DESCRIPTION OF THE DRAWINGS

FIG. 1 is a side view of a rotary engine rotor housing assembly, including a front side housing, rotor housing, rear side housing and barrel valve, according to an embodiment of the present invention;

FIG. 2 is a rear view of the front side housing, taken along line 2-2 of FIG. 1, with internal features shown in broken lines;

FIG. 3 is a rear view of the rotor housing, taken along line 3-3 of FIG. 1, with internal features shown in broken lines;

FIG. 4 is a front view of the rear side housing, taken along line 4-4 of FIG. 1, with internal features shown in broken lines;

FIGS. 5 and 6 are perspective views of the barrel valve of FIG. 1;

FIG. 7 is a side view of a prior art rotary engine rotor housing assembly, including a front side housing, rotor housing, rear side housing and barrel valve;

FIG. 8 is a rear view of the front side housing, taken along line 8-8 of FIG. 7, with internal features shown in broken lines;

FIG. 9 is a rear view of the rotor housing, taken along line 9-9 of FIG. 7, with internal features shown in broken lines;

FIG. 10 is a front view of the rear side housing, taken along line 10-10 of FIG. 7, with internal features shown in broken lines; and

FIG. 11 is a side view of the barrel valve of FIG. 7, with internal features shown in broken lines.

### DETAILED DESCRIPTION OF A PREFERRED EMBODIMENT

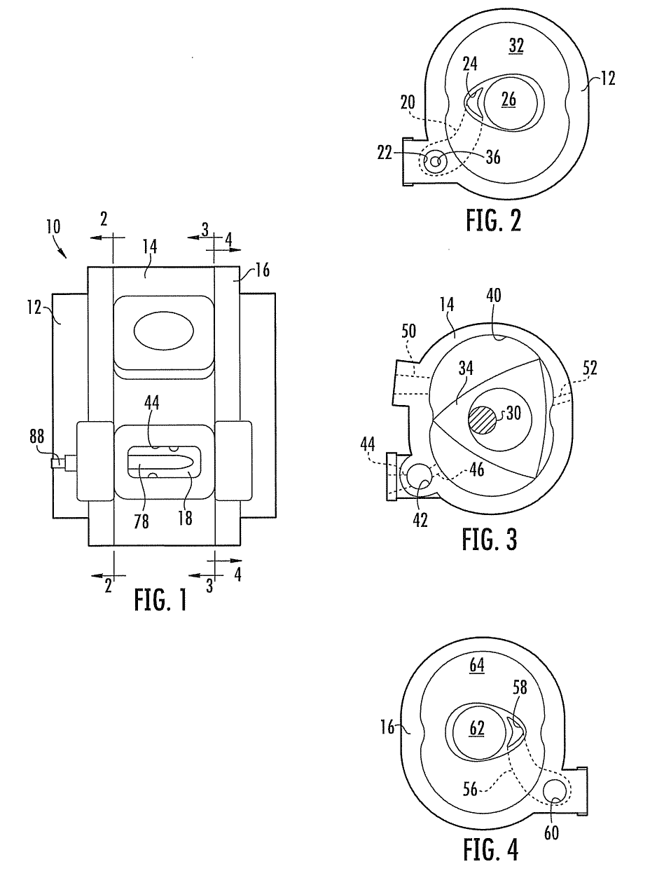

With reference to FIG. 1, a rotary engine rotor housing assembly 10, according to an embodiment of the present invention, includes a front side housing 12, a rotor housing 14, a rear side housing 16, and a barrel valve 18. Directional terms, such as front and rear, are used herein for relative referential purposes only, and do not limit the possible absolute orientations of the housing assembly 10 thus described.

Referring to FIGS. 1 and 2, the front side housing 12 attaches to the front of the rotor housing 14 and defines a front side internal passage 20 extending between a front side internal passage inlet 22 and a front side internal passage outlet 24. The front side housing 12 further defines a front side housing central opening 26 proximate to the front side internal passage outlet 24. The front side central opening 26 accommodates forward bearings (not shown) for a rotary engine drive shaft 30 (FIG. 3). The front side housing 12 has a forward machined surface 32 that sealingly engages a front surface of a rotor 34 (FIG. 3). A barrel valve stem passage 36 is defined extending through the front side housing 12 concentric with the front side internal passage inlet 22.

Referring to FIGS. 1 and 3, the rotor housing 14 defines an internal chamber 40 therein, dimensioned to accommodate the rotor 34 therein to be eccentrically rotatable about the drive shaft 30. A barrel valve housing 42 is defined extending through the rotor housing 14. A rotor housing assembly fuel/air inlet passage 44 is defined extending from outside the rotor housing assembly 10 to the barrel valve housing 42. An internal chamber fuel/air inlet passage 46 is defined extending into the internal chamber 40 from the barrel valve housing 42.

An exhaust passage 50 and spark plug passage 52 are also defined extending from the internal chamber 40 to outside the rotor housing 14. The spark plug passage 52 is dimensioned to sealingly accommodate a spark plug (not shown) therein.

Referring to FIGS. 1 and 4, the rear side housing 16 attaches to the rear of the rotor housing 14 and defines a rear side internal passage 56 extending between a rear side internal passage inlet 58 and a rear side internal passage outlet 60. Together with the front side internal passage 20, the rear side internal passage 56 defines an internal lubrication flow path within the housing assembly 10.

The rear side housing 16 further defines a rear side housing central opening 62 proximate to the rear side internal passage inlet 58. The rear side housing central opening 62 accommodates rear bearings (not shown) for the rotary engine drive shaft 30. The rear side housing 16 has a rear machined surface 64 that sealingly engages a rear surface of the rotor 34 (FIG. 3).

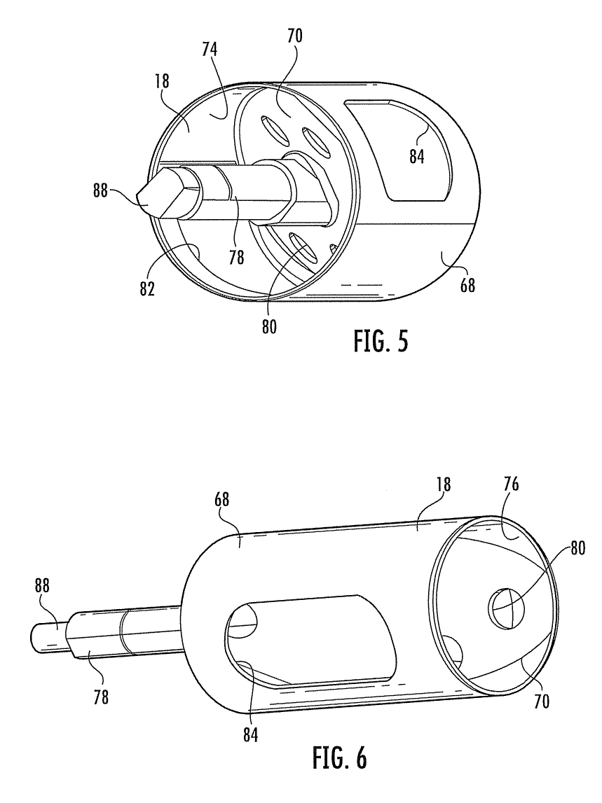

Referring to FIGS. 5 and 6, the barrel valve 18 includes a substantially cylindrical valve member 68 traversed by a separation plate 70 to define an inlet chamber 74 and an outlet chamber 76 within the interior volume, and opening out respective ends, of the valve member 68. The valve member 68 is dimensioned to be closely accommodated within the barrel valve housing 42. The barrel valve 18 further includes a valve stem 78 connected to the valve member 68 by the separation plate 70. A plurality of discrete idling openings 80 are defined in the separation plate 70 extending between the inlet chamber 74 and the outlet chamber 76.

A fuel/air inlet opening 82 is defined through the valve member 68 opening into the inlet chamber 74 and is dimensioned to substantially match the shape of the adjacent end of the rotor housing assembly fuel/air inlet passage 44. A fuel/air outlet opening 84 is defined through the valve member 68 opening into the outlet chamber 76 and is dimensioned to substantially match the shape of the adjacent end of the internal chamber fuel/air inlet passage 46.

The valve stem 78 has a distal end 88 adapted for engagement by an operating mechanism (not shown) adapted to rotate the barrel valve 18 between an idle and a full power position.

It will be appreciated that the rotary engine rotor housing assembly 10 can incorporate additional features beyond those described above, such as bolts, threaded bores, additional bearings, gaskets, seals, cooling channels, mounting points, and other components known in the rotary engine art. Various construction materials can also be used. Preferably, the front side housing 12, rotor housing 14 and rear side housing 16 and barrel valve 18 are made from aluminum, and the rotor 34 from steel with high wear rotor surfaces being formed from ceramics. However, other materials can be used as desired or dictated by design requirements.

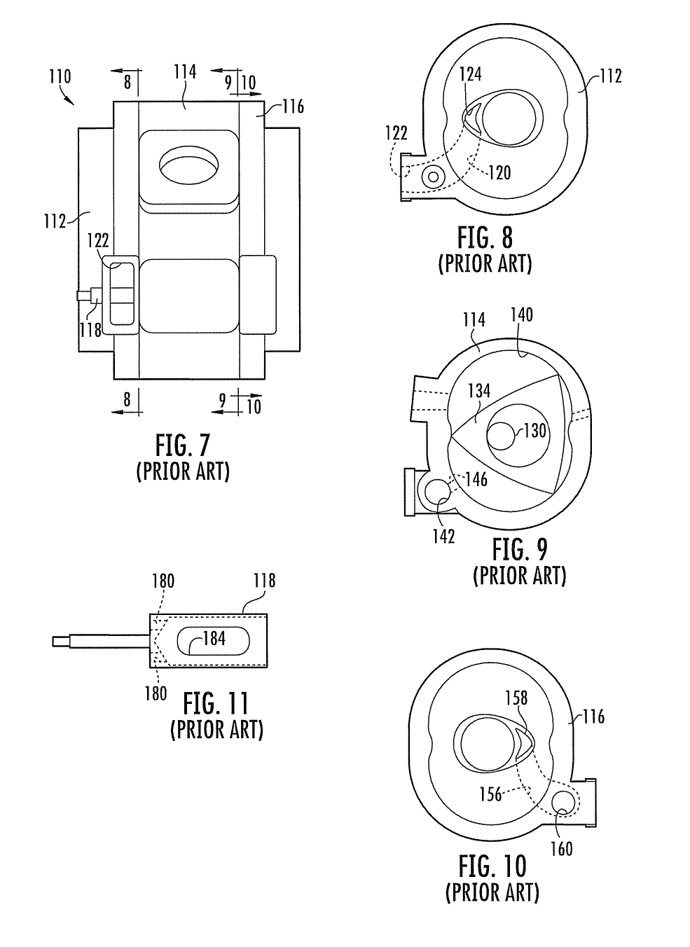

In addition to being applied to the design and manufacture of new rotary engine housing assemblies, the aspects of the present invention can be applied to retrofits of existing rotary engine housing assemblies. For example, referring to FIGS. 7-11, the barrel valve 118 can be replaced with the barrel valve 18, the opening 122 can be blanked, and a new inlet passage can be machined into barrel valve housing 160 through the rotor housing 114. To facilitate proper alignment of passage openings onto the barrel valve housing, the barrel valve housing can be bored slightly larger and a sleeve with properly aligned passage openings can be installed.

In operation, with reference to FIGS. 1-6, the barrel valve 18 is rotated by the operating mechanism to regulate the flow of fuel/air mixture into the internal chamber 40. The fuel/air mixture first enters the housing assembly 10 through the rotor housing assembly fuel/air inlet passage 44 and travels toward the barrel valve housing 42.

At idle, the barrel valve 18 is rotated such that the valve member 68 almost completely occludes the adjacent ends of the rotor housing fuel/air inlet passage 44 and the internal chamber fuel/air inlet passage 46, with only a minimal portion of the fuel/air inlet and outlet openings 82, 84 exposed. The fuel/air mixture enters the inlet chamber 74 and substantially all of the relatively small amount of fuel/air mixture flows through the idling openings 80 directly to the outlet chamber 76. From the outlet chamber 76, the fuel/air mixture enters the internal chamber 40 through the internal chamber fuel/air inlet passage 46. In the internal chamber, the fuel/air mixture is combusted and exhausted in a manner known in the art.

Above idle, the barrel valve 18 is rotated such that a larger portion of the fuel/air inlet and outlet openings 82, 84 are aligned with the respective adjacent ends of the rotor housing fuel/air inlet passage 44 and the internal chamber fuel/air inlet passage 46. The pressure drop across the internal chamber 40 is sufficient that a significant portion of the fuel/air mixture flows from the inlet chamber 74, out the corresponding open end of the valve member 68 and into the front side internal passage inlet 22.

The fuel/air mixture flows from thence through the front side internal passage 20 and out the front side internal passage outlet 24. The fuel/air mixture helps to lubricate the various drive train components as it passes between the rotor 34 and drive shaft 30 towards the rear side housing 16.

The fuel air/mixture enters the rear side internal passage 56 through the rear side internal passage inlet 58 and exits through the rear side internal passage outlet 60. The fuel/air mixture again enters the barrel valve housing 42, this time into the outlet chamber 76 through its respective open end of the valve member 68.

The fuel/air mixture passes through the fuel/air outlet opening 84 and into the internal chamber fuel/air inlet passage 46. Once in the internal chamber, the fuel/air mixture is combusted and exhausted in a manner known in the art.

It will be appreciated that a rotor housing assembly according to the present invention can regulate the entrance of the fuel/air mixture into the housing assembly and from thence into the internal chamber with a single valve. Accordingly, the need for a separate mechanism to regulate entrance of the fuel/air mixture into the housing assembly is eliminated, along with the concomitant mechanical complexity and weight. Thus, the rotary engine power-to-weight ratio can be increased.

While a rotor housing assembly according to the present invention can be used in substantially any rotary engine application, such as automobiles, watercraft and aircraft, it will be appreciated that the present invention is particularly advantageous in applications where low weight, high power-to-weight ratio and/or mechanical simplicity are most valuable. For example, the present invention offers significant advantages in personal watercraft and small aircraft applications.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and the claims appended hereto.

What is claimed is:

1. A rotary engine rotor housing assembly comprising:
a rotor housing at least partially defining an internal chamber therein;
a front side housing arranged on a front side of the rotor housing;
a rear side housing arranged on a rear side of the rotor housing; and
a barrel valve arranged in a barrel valve housing defined in the housing assembly;
wherein an internal lubrication flow path is defined within the housing assembly, and the barrel valve is operable to regulate entrance of fuel/air flow both into the housing assembly and from the internal lubrication flow path into the internal chamber.

2. The assembly of claim 1, wherein the internal lubrication flow path includes a front side internal passage, defined in the front side housing, and a rear side internal passage, defined in the rear side housing.

3. The assembly of claim 1, wherein the barrel valve housing is defined in the rotor housing.

4. The assembly of claim 3, wherein the internal lubrication flow path includes a front side internal passage, defined in the front side housing, and a rear side internal passage, defined in the rear side housing, both the front and rear side internal passages terminating at opposite ends of the barrel valve housing.

5. The assembly of claim 3, wherein a rotor housing assembly fuel/air inlet passage, extending from outside the rotor housing assembly to the barrel valve housing, and an internal chamber fuel/air inlet passage, extending from the barrel valve housing to the internal chamber, are both defined in the rotor housing.

6. The assembly of claim 5, wherein a fuel/air inlet opening and a fuel/air outlet opening are defined in the barrel valve to be simultaneously alignable with the rotor housing assembly fuel/air inlet passage and the internal chamber fuel/air inlet passage, respectively.

7. The assembly of claim 1, wherein the barrel valve includes a substantially cylindrical valve member surrounding an interior volume.

8. The assembly of claim 7, wherein the interior volume of the valve member is divided into an inlet chamber and an outlet chamber by a separation plate.

9. The assembly of claim 8, wherein a fuel/air inlet opening and a fuel/air outlet opening are defined in the valve member communicating directly with the inlet chamber and an outlet chamber, respectively.

10. The assembly of claim 9, wherein the valve member is open on opposite ends thereof and the separation plate traverses the interior volume such that each open end communicates directly with only a respective one of the inlet and outlet chambers.

11. The assembly of claim 10, wherein the internal lubrication flow path includes a front side internal passage, defined in the front side housing, and a rear side internal passage, defined in the rear side housing, both the front and rear side internal passages terminating at opposite ends of the barrel valve housing so as to communicate directly with only a respective one of the inlet and outlet chambers.

12. The assembly of claim 8, wherein a plurality of discrete idling openings are formed in the separation plate in communication with both the inlet and outlet chambers.

13. A barrel valve for a rotary engine rotor housing assembly, the valve comprising:
a valve element defining an interior volume, a fuel/air inlet opening and a fuel/air outlet opening being defined in the valve member in communication with the interior volume; and
a separation plate dividing the interior volume into an inlet chamber, directly communicating with the fuel/air inlet opening, and an outlet chamber, directly communicating with the fuel/air outlet opening.

14. The valve of claim 13, further comprising a valve stem adapted for engagement with an operating mechanism.

15. The valve of claim 14, wherein the valve stem is connected to the separation plate.

16. The valve of claim 13, wherein the separation plate diagonally traverses the interior volume.

17. The valve of claim 13, wherein a plurality of discrete idling openings are formed in the separation plate in communication with both the inlet and outlet chambers.

18. The valve of claim 13, wherein the valve member is open on opposite ends thereof and the separation plate traverses the interior volume such that each open end communicates directly with only a respective one of the inlet and outlet chambers.

19. A method of regulating fuel/air mixture flow in a rotary engine rotor housing assembly, the method comprising:
arranging a single valve in the path of a fuel/air mixture both:
from outside the housing assembly into an internal lubrication flow path; and
from the internal lubrication flow path into an internal chamber; and
operating the single valve to simultaneously regulate the fuel/air flow into the housing assembly and into the internal chamber.

20. The method of claim 19, wherein the single valve is a barrel valve and operating the single valve includes at least partially rotating the barrel valve.
